(19) United States
(12) Patent Application Publication
(10) Pub. No.: US 2026/0368143 A1
(43) Pub. Date: Nov. 19, 2026

(54) VIRTUAL WORKSPACE STORAGE HAVING INDEPENDENT LIFECYCLE

(71) Applicant: Microsoft Technology Licensing, LLC, Redmond, WA (US)

(72) Inventors: Nicholas Leo DEPINET, Newcastle, WA (US); Trent Jarvis BYFIELD, Seattle, WA (US); German David OBANDO CHACON, Kirkland, WA (US); Denizhan YIGITBAS, Golden, CO (US); Anthony Oreste CANGIALOSI, Seattle, WA (US); Sneha NAGENDRA, Kirkland, WA (US)

(21) Appl. No.: 19/210,994

(22) Filed: May 16, 2025

(51) Int. Cl. G06F 16/188; G06F 8/61

(52) U.S. Cl. CPC G06F 16/188; G06F 8/61

(57) ABSTRACT

Techniques are described herein that are capable of establishing virtual desktop environments using a virtual workspace storage having an independent lifecycle. A virtual workspace storage is generated in a cloud environment. The virtual workspace storage has a file system installed thereon. Virtual desktop environments are established by attaching the virtual workspace storage to virtual compute instances in the cloud environment. The virtual compute instances are configured to access the file system, which is installed on the virtual workspace storage. A lifecycle of the virtual workspace storage is independent from respective lifecycles of the virtual compute instances.

### BACKGROUND

Historically, virtual desktop infrastructure (VDI) solutions allow users to have ephemeral compute or workstation replacement compute hosted in the cloud with remote access provided by technologies such as a remote desktop protocol™ technology, developed and distributed by Microsoft Corporation; secure shell (SSH®) connections, developed by Tatu Ylönen and distributed by SSH Communications Security Corporation; or a dev tunnels™ service, developed and distributed by Microsoft Corporation. A conventional VDI solution often semantically matches a local computer and therefore usually includes a processor, a disk, a random access memory (RAM), and potentially other component(s) such as a graphics processing unit (GPU) or a neural processing unit (NPU). Accordingly, the lifecycle of a conventional VDI instance typically resembles the lifecycle of a regular virtual machine in a home desktop computer or a laptop. The VDI instance traditionally is created with a static set of resources, which the VDI instance leverages during its lifecycle, and the VDI instance releases the static set of resources at the end of its lifecycle.

### SUMMARY

It may be desirable to create a VDI solution in which a virtual workspace storage has a lifecycle that is independent from lifecycle(s) of respective virtual compute instance(s) to which the virtual workspace storage is attached. A virtual workspace storage is a virtual storage that exists in a cloud environment. A virtual compute instance is virtual processing functionality that runs in a cloud environment (e.g., on a cloud infrastructure). Examples of a virtual compute instance include but are not limited to a virtual machine (VM), a virtual central processing unit (CPU), a virtual graphics processing unit (GPU) (e.g., a serverless GPU), and an operating system. Examples of an operating system include but are not limited to a Linux® operating system, developed by Linus Torvalds and distributed under the GNU Project; a Berkeley Software Distribution™ (BSD) operating system, developed and distributed by the Computer Systems Research Group (CSRG) of the University of California, Berkeley, or descendants thereof; an iOS™ operating system, developed and distributed by Apple Inc.; a Microsoft Windows® operating system, developed and distributed by Microsoft Corporation; and a UNIX™ operating system, developed and distributed by AT&T.

Attaching a virtual workspace storage to a virtual compute instance enables the virtual compute instance to process information stored on the virtual workspace storage. The virtual workspace storage having a lifecycle that is different from lifecycle(s) of respective virtual compute instance(s) to which the virtual workspace storage is attached enables the virtual workspace storage to outlive the virtual compute instance(s). For instance, any one or more (e.g., all) of the virtual compute instance(s) may be terminated without affecting the lifecycle of the virtual workspace storage. A virtual compute instance may be detached from the virtual workspace storage, rebuilt, and re-attached to the virtual workspace storage without a need to reconfigure the virtual workspace storage.

A variety of situations may require a VDI user to create a new virtual compute instance and to start from scratch. For example, an operating system may become substantially corrupted and therefore may not be able to provide a shell, even though a remote access session is started. In another example, a user may need additional storage space because the user's tools require more space than originally planned. In yet another example, the user may desire to have a clean virtual compute instance with a latest version of the tools running thereon. In still another example, installation of an operating system may consume more time and/or resources than desired. When a user creates a replacement virtual compute instance, the user may avoid performing manual operations to bring back configurations, tools, source code, images, audio files, or other assets to the user's storage by utilizing a virtual workspace storage having a lifecycle that is independent from a lifecycle of the replacement virtual compute instance. For example, the configurations, tools, source code, images, audio files, and other assets may be incorporated into the virtual workspace storage prior to attaching the virtual workspace storage to the replacement virtual compute instance. Accordingly, the user may be more likely to rebuild a virtual compute instance due to the reduced effort and time involved with utilizing the virtual workspace storage. A user of a virtual compute instance may need a separate, specialized virtual compute instance (e.g., a virtual machine with GPU functionality to analyze a data set). By utilizing a virtual workspace storage, the user may reduce cost, time, and/or resources associated with analyzing the data, for example, by obviating a need to use an intermediary storage system to move the data between the virtual compute instance and the separate, specialized virtual compute instance.

Various approaches are described herein for, among other things, establishing virtual desktop environments using a virtual workspace storage having an independent lifecycle. In an example approach, a virtual workspace storage is generated in a cloud environment. The virtual workspace storage has a file system installed thereon. Virtual desktop environments are established by attaching the virtual workspace storage to virtual compute instances in the cloud environment. The virtual compute instances are configured to access the file system, which is installed on the virtual workspace storage. A lifecycle of the virtual workspace storage is independent from respective lifecycles of the virtual compute instances.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example independent lifecycle-based virtual desktop environment system in accordance with an embodiment.

FIGS. 2 and 4-6 depict flowcharts of example methods for establishing virtual desktop environments using a virtual workspace storage having an independent lifecycle in accordance with embodiments.

FIG. 3 depicts a flowchart of an example method for generating a virtual workspace storage in accordance with an embodiment.

FIG. 7 is a block diagram of an example computing system in accordance with an embodiment.

FIG. 8 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to create a VDI solution in which a virtual workspace storage has a lifecycle that is independent from lifecycle(s) of respective virtual compute instance(s) to which the virtual workspace storage is attached. A virtual workspace storage is a virtual storage that exists in a cloud environment. A virtual compute instance is virtual processing functionality that runs in a cloud environment (e.g., on a cloud infrastructure). Examples of a virtual compute instance include but are not limited to a virtual machine (VM), a virtual central processing unit (CPU), a virtual graphics processing unit (GPU) (e.g., a serverless GPU), and an operating system. Examples of an operating system include but are not limited to a Linux® operating system, developed by Linus Torvalds and distributed under the GNU Project; a Berkeley Software Distribution™ (BSD) operating system, developed and distributed by the Computer Systems Research Group (CSRG) of the University of California, Berkeley, or descendants thereof; an iOS™ operating system, developed and distributed by Apple Inc.; a macOS® operating system, developed and distributed by Apple Inc.; a Google Chrome® operating system, developed and distributed by Google LLC; an Android® operating system, developed and distributed by Google LLC; a Haiku® operating system, developed and distributed by Haiku, Inc.; a Microsoft Windows® operating system, developed and distributed by Microsoft Corporation; and a UNIX™ operating system, developed and distributed by AT&T.

Attaching a virtual workspace storage to a virtual compute instance enables the virtual compute instance to process information stored on the virtual workspace storage. The virtual workspace storage having a lifecycle that is different from lifecycle(s) of respective virtual compute instance(s) to which the virtual workspace storage is attached enables the virtual workspace storage to outlive the virtual compute instance(s). For instance, any one or more (e.g., all) of the virtual compute instance(s) may be terminated without affecting the lifecycle of the virtual workspace storage. A virtual compute instance may be detached from the virtual workspace storage, rebuilt, and re-attached to the virtual workspace storage without a need to reconfigure the virtual workspace storage.

A variety of situations may require a VDI user to create a new virtual compute instance and to start from scratch. For example, an operating system may become substantially corrupted and therefore may not be able to provide a shell, even though a remote access session is started. In another example, a user may need additional storage space because the user's tools require more space than originally planned. In yet another example, the user may desire to have a clean virtual compute instance with a latest version of the tools running thereon. In still another example, installation of an operating system may consume more time and/or resources than desired. When a user creates a replacement virtual compute instance, the user may avoid performing manual operations to bring back configurations, tools, source code, images, audio files, or other assets to the user's storage by utilizing a virtual workspace storage having a lifecycle that is independent from a lifecycle of the replacement virtual compute instance. For example, the configurations, tools, source code, images, audio files, and other assets may be incorporated into the virtual workspace storage prior to attaching the virtual workspace storage to the replacement virtual compute instance. Accordingly, the user may be more likely to rebuild a virtual compute instance due to the reduced effort and time involved with utilizing the virtual workspace storage. A user of a virtual compute instance may need a separate, specialized virtual compute instance (e.g., a virtual machine with GPU functionality to analyze a data set). By utilizing a virtual workspace storage, the user may reduce cost, time, and/or resources associated with analyzing the data, for example, by obviating a need to use an intermediary storage system to move the data between the virtual compute instance and the separate, specialized virtual compute instance.

Example embodiments described herein are capable of establishing virtual desktop environments using a virtual workspace storage having an independent lifecycle. Example techniques described herein have a variety of benefits as compared to conventional VDI solutions. For instance, the example techniques are capable of reducing an amount of time and/or resources (e.g., processor cycles, memory, network bandwidth) that is consumed by a computing system to establish virtual desktop environments. In an example implementation, by generating a virtual workspace storage, which has a file system installed thereon, in a cloud environment; and establishing virtual desktop environments by attaching the virtual workspace storage to virtual compute instances, which are configured to access the file system that is installed on the virtual workspace storage, in the cloud environment such that a first lifecycle of the virtual workspace storage is independent from respective second lifecycles of the virtual compute instances, the example techniques reduce the amount of time and/or resources that is consumed to establish the virtual desktop environments.

In an aspect, the example techniques automate establishing the virtual desktop environments. For instance, the example techniques may automate any one or more of the operations described above with regard to the example implementation. In another aspect, by reducing the amount of time and/or resources that is consumed by a computing system to establish virtual desktop environments, the efficiency of the computing system is increased. In yet another aspect, by reducing the amount of time and/or resources that is consumed by a computing system to establish virtual desktop environments, a cost associated with establishing the virtual desktop environments is reduced.

In an aspect, by reducing the amount of time that is consumed to establish virtual desktop environments, the example techniques increase a user experience and/or efficiency of user(s) who use the virtual desktop environments. The example techniques may reduce a number of tasks that are manually performed by the user(s) to establish the virtual desktop environments by utilizing a virtual workspace storage that has an independent lifecycle. In an example, the lifecycle of the virtual workspace storage is independent from the lifecycles of the virtual compute instances that are attached to the virtual workspace storage.

The example techniques enable a virtual workspace storage to be attached (e.g., connected) to as many virtual compute instances as needed at the same time, which enables a variety of scenarios. In a first example scenario, asset files are automatically updated overnight as they become available. In a second example scenario, a GPU-enabled Linux® container instance processes data in a directory of the virtual workspace storage while (e.g., in parallel) a modest 8-core CPU consumes the processed data to have an artificial intelligence (AI) engine use the processed data as context to produce insights and code based on the processed data in a way that resembles a smart data refinery and code production pipeline. In a third example scenario, a low-trust AI agent running in its own separate compute instance may have read-only access to a directory in the virtual workspace storage and proactively communicate with a user to make suggestions or provide alerts in real-time. In a fourth example scenario, a high-trust system monitors content of the virtual workspace storage on behalf of an organization and produces insights as needed. In a fifth example scenario, a directory in the virtual workspace storage is available as a read-only set of files that are served centrally for a team but appear to be local (e.g., native) in the file system of the user. In a sixth example scenario, file transfer between virtual desktop environments of respective users performed transparently and rapidly.

The example techniques enable content of the virtual workspace storage to be instantly accessible to the virtual compute instances as a result of the virtual workspace storage being attached to the virtual compute instances. The example techniques are capable of reducing an amount of time that is consumed to provision the virtual compute instances (e.g., based on use of the virtual workspace storage resulting in smaller container images). The example techniques enable compute-intensive tools (e.g., a live unit testing tool or a code analysis tool) to be run externally from a device of a user on a snapshot of the virtual workspace storage. The example techniques reduce a number of image refreshes that are performed with regard to an image of a virtual compute instance.

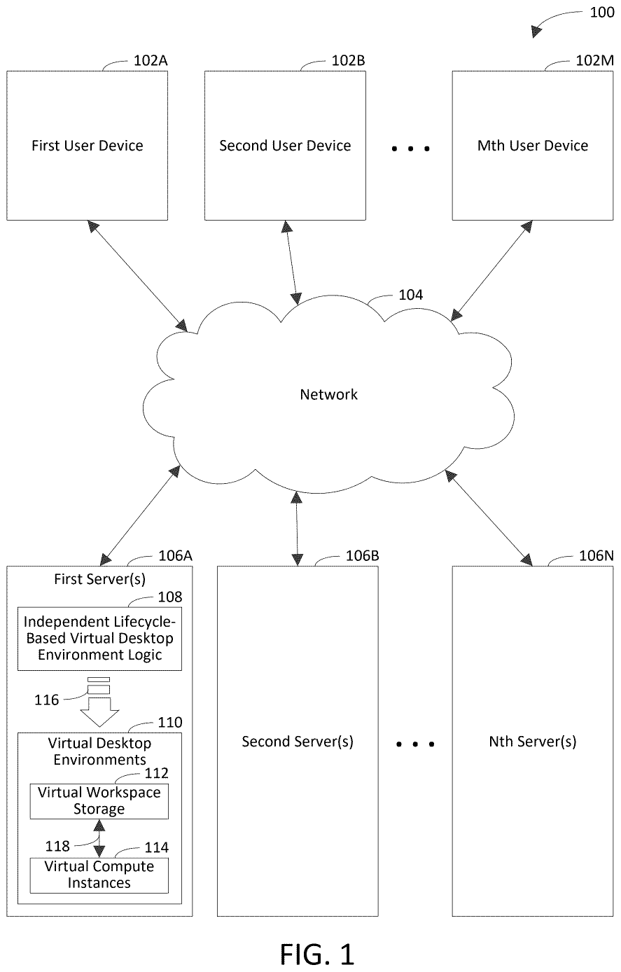

FIG. 1 is a block diagram of an example independent lifecycle-based virtual desktop environment system 100 in accordance with an embodiment. Generally speaking, the independent lifecycle-based virtual desktop environment system 100 operates to provide information to users in response to requests (e.g., hypertext transfer protocol (HTTP) requests) that are received from the users. In an aspect, the information includes documents (Web pages, images, audio files, video files, etc.), output of executables, and/or any other suitable type of information. In accordance with example embodiments described herein, the independent lifecycle-based virtual desktop environment system 100 establishes virtual desktop environments 110 using a virtual workspace storage 112 having an independent lifecycle. Detail regarding techniques for establishing virtual desktop environments using a virtual workspace storage having an independent lifecycle is provided in the following discussion.

As shown in FIG. 1, the independent lifecycle-based virtual desktop environment system 100 includes a plurality of user devices 102A-102M, a network 104, and a plurality of servers 106A-106N. Communication among the user devices 102A-102M and the servers 106A-106N is carried out over the network 104 using well-known network communication protocols. In an aspect, the network 104 is a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors. In an example, the one or more processors are on a same (e.g., single) device. In another example, the one or more processors are distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M are able to access information that is available via the domains. In an aspect, the domain include Web page(s). In an example, the Web page(s) are provided as hypertext markup language (HTML) documents and objects (e.g., files) that are linked therein.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the independent lifecycle-based virtual desktop environment system 100.

One example type of computer program that may be executed by one or more of the servers 106A-106N is a cloud computing program (e.g., a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

In an aspect, the cloud computing program provides hosted service(s) according to a service model. Examples of a service model include but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. In an aspect, one or more of the example techniques described herein are implemented using a cloud computing program. In an example, a software product (e.g., a subscription service, a non-subscription service, or a combination thereof) includes the cloud computing program, and the software product is configured to perform the example techniques.

It will be recognized that the example techniques described herein may be implemented using a cloud computing program.

Another example type of computer program, which may be executed by one or more of the servers 106A-106N and/or one or more of the user devices 102A-102M, is a developer tool. A developer tool is a computer program that performs diagnostic operations (e.g., identifying a source of a problem, debugging, profiling, and/or controlling) with respect to program code. Examples of a developer tool include but are not limited to an artificial intelligence (AI) service suite, an integrated development environment (IDE), and a web development platform.

An AI service suite is a program that provides tools that are usable by software developers to build, deploy, and scale AI applications (e.g., AI models). In an aspect, the AI service suite enables the software developers to build, deploy, and/or scale AI application(s) without needing extensive AI or data science expertise. An example of an AI service suite is an Azure AI Cloud™ suite, developed distributed by Microsoft Corporation.

An integrated development environment (IDE) is a program that provides tools that are usable by software developers to develop software. In an aspect, the IDE includes a source code editor, build automation tool(s), a debugger, a compiler, and/or an interpreter. Examples of an IDE include but are not limited to a Microsoft Visual Studio® IDE, developed and distributed by Microsoft Corporation; an AppCode® IDE, a PhpStorm® IDE, a Rider® IDE, a WebStorm® IDE, etc., developed and distributed by JetBrains s.r.o.; a JDeveloper® IDE, developed and distributed by Oracle International Corporation; a NetBeans® IDE, developed and distributed by Sun Microsystems, Inc.; an Eclipse™ IDE, developed and distributed by Eclipse Foundation; and an Android Studio™ IDE, developed and distributed by Google LLC and JetBrains s.r.o.

A web development platform is a program that provides tools that are usable by software developers to create, deploy, and manage web applications. In an aspect, the tools perform functions such as web hosting, database management, and/or content delivery. Examples of a web development platform include but are not limited to a Windows Azure® platform, developed and distributed by Microsoft Corporation; an Amazon Web Services® platform, developed and distributed by Amazon.com, Inc.; a Google App Engine® platform, developed and distributed by Google LLC; a VMWare® platform, developed and distributed by VMWare, Inc.; and a Force.com® platform, developed and distributed by Salesforce, Inc.

It will be recognized that the example techniques described herein may be implemented using a developer tool. In an aspect, a developer tool is incorporated into a cloud computing program.

The first server(s) 106A are shown to include independent lifecycle-based virtual desktop environment logic 108 for illustrative purposes. The independent lifecycle-based virtual desktop environment logic 108 is configured to establish the virtual desktop environments 110 using the virtual workspace storage 112 having an independent lifecycle. In an example implementation, the independent lifecycle-based virtual desktop environment logic 108 generates the virtual workspace storage 112 in a cloud environment. The virtual workspace storage 112 has a file system installed thereon. The independent lifecycle-based virtual desktop environment logic 108 establishes the virtual desktop environments 110, as indicated by arrow 116, by attaching the virtual workspace storage 112 to virtual compute instances 114 in the cloud environment, as indicated by bidirectional arrow 118. The virtual compute instances 114 are configured to access the file system, which is installed on the virtual workspace storage 112. A lifecycle of the virtual workspace storage 112 is independent from respective lifecycles of the virtual compute instances 114.

The independent lifecycle-based virtual desktop environment logic 108 may be implemented in various ways to establish the virtual desktop environments 110 using the virtual workspace storage 112 having an independent lifecycle, including being implemented in hardware, software, firmware, or any combination thereof. In an aspect, the independent lifecycle-based virtual desktop environment logic 108 is implemented as computer program code configured to be executed in one or more processors. In another aspect, at least a portion of the independent lifecycle-based virtual desktop environment logic 108 is implemented as hardware logic (e.g., electrical circuitry). In an example of this aspect, at least a portion of the independent lifecycle-based virtual desktop environment logic 108 is implemented in a field-programmable gate array (FPGA), an application-specific integrated circuit (ASIC), an application-specific standard product (ASSP), a system-on-a-chip system (SoC), and/or a complex programmable logic device (CPLD). In an example, each SoC includes an integrated circuit chip that includes one or more of a processor (a microcontroller, microprocessor, digital signal processor (DSP), etc.), memory, one or more communication interfaces, and/or further circuits and/or embedded firmware to perform its functions.

In an aspect, the independent lifecycle-based virtual desktop environment logic 108 is (or is included in) a cloud computing program and/or a developer tool.

The independent lifecycle-based virtual desktop environment logic 108 is shown to be incorporated in the first server(s) 106A for illustrative purposes and is not intended to be limiting. It will be recognized that the independent lifecycle-based virtual desktop environment logic 108 (or any portion(s) thereof) may be incorporated in any one or more of the servers 106A-106N, any one or more of the user devices 102A-102M, or any combination thereof. In an example, client-side aspects of the independent lifecycle-based virtual desktop environment logic 108 are incorporated in one or more of the user devices 102A-102M, and server-side aspects of independent lifecycle-based virtual desktop environment logic 108 are incorporated in one or more of the servers 106A-106N.

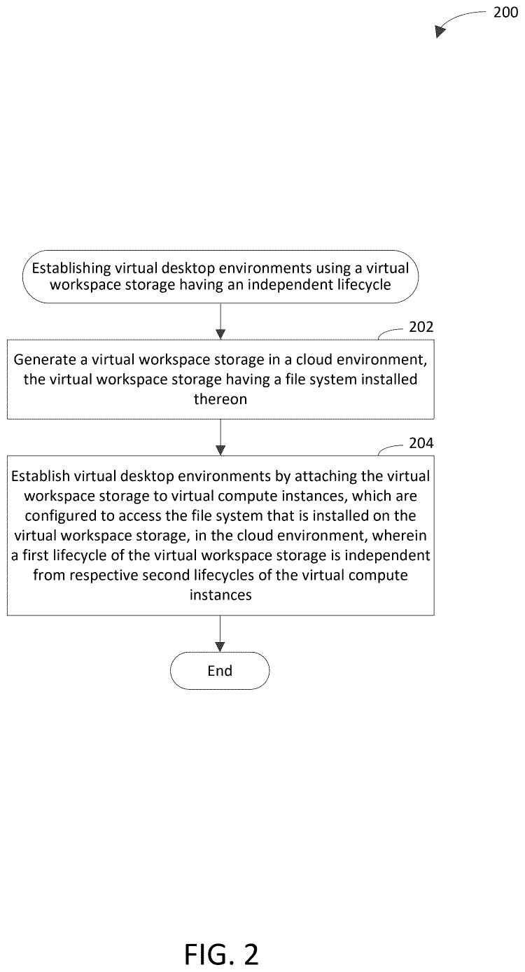

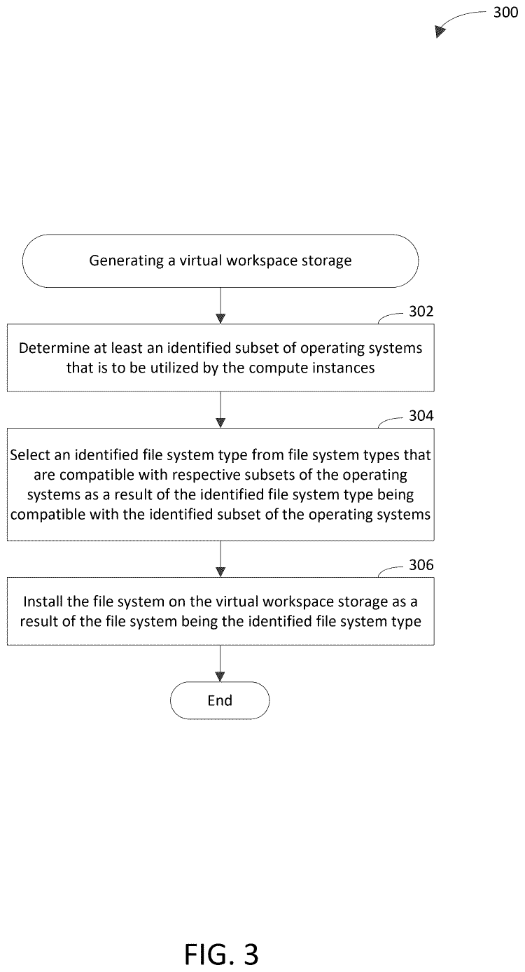

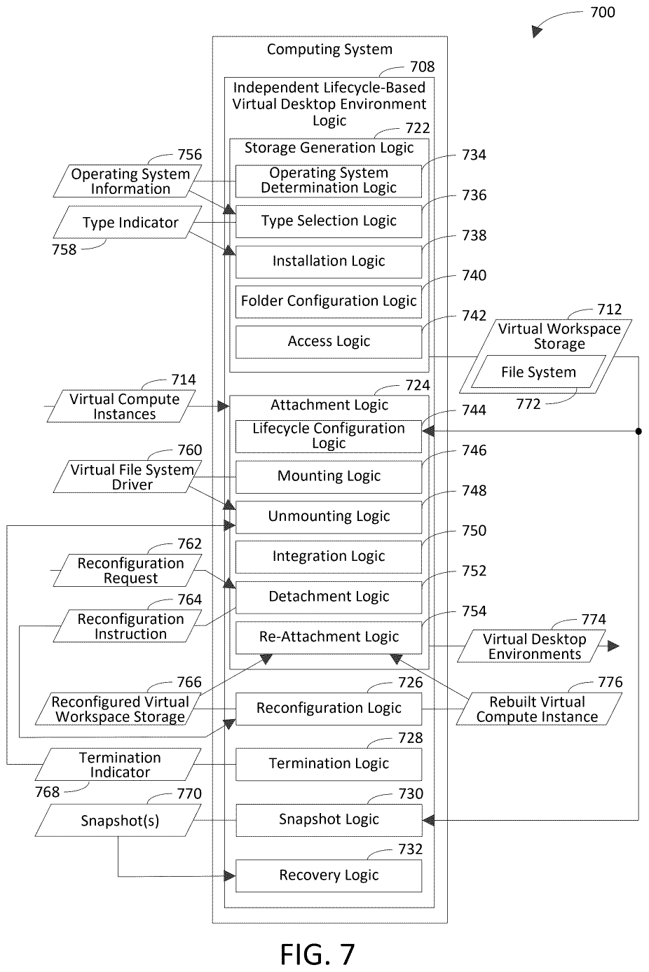

FIGS. 2 and 4-6 depict flowcharts 200, 400, 500, and 600 of example methods for establishing virtual desktop environments using a virtual workspace storage having an independent lifecycle in accordance with embodiments. FIG. 3 depicts a flowchart 300 of an example method for generating a virtual workspace storage in accordance with an embodiment. Flowcharts 200, 300, 400, 500, and 600 may be performed by the first server(s) 106A shown in FIG. 1, for example. For illustrative purposes, flowcharts 200, 300, 400, 500, and 600 are described with respect to a computing system 700 shown in FIG. 7, which is an example implementation of the first server(s) 106A. As shown in FIG. 7, the computing system 700 includes independent lifecycle-based virtual desktop environment logic 708. The independent lifecycle-based virtual desktop environment logic 708 includes storage generation logic 722, attachment logic 724, reconfiguration logic 726, termination logic 728, snapshot logic 730, and recovery logic 732. The storage generation logic 722 includes operating system determination logic 734, type selection logic 736, installation logic 738, folder configuration logic 740, and access logic 742. The attachment logic 724 includes lifecycle configuration logic 744, mounting logic 746, unmounting logic 748, integration logic 750, detachment logic 752, and re-attachment logic 754. Further structural and operational embodiments will be apparent to persons skilled in the relevant art(s) based on the discussion regarding flowcharts 200, 300, 400, 500, and 600.

As shown in FIG. 2, the method of flowchart 200 begins at step 202. In step 202, a virtual workspace storage is generated in a cloud environment. The virtual workspace storage has a file system installed thereon. In an aspect, the file system is a new technology file system (NTFS®), developed and distributed by Microsoft Corporation. In an example of this aspect, the NTFS® file system is installed on the virtual workspace storage as a result of the NTFS® file system being compatible with the Microsoft Windows® operating system. For instance, the virtual compute instances may be configured to execute the Microsoft Windows® operating system. In another aspect, the file system is a resilient file system (ReFS®), developed and distributed by Microsoft Corporation. In an example of this aspect, the ReFS® file system is installed on the virtual workspace storage as a result of the ReFS® file system being compatible with the Linux® operating system, the Berkeley Software Distribution™ (BSD) operating system, the iOS™ operating system, the macOS® operating system, the Google Chrome® operating system, the Android® operating system, the Haiku® operating system, the Microsoft Windows® operating system, the UNIX™ operating system, or any combination thereof. For instance, any one or more of the virtual compute instances may be configured to execute any one or more of the aforementioned operating systems. In yet another aspect, the virtual workspace storage has performance characteristics of a solid-state drive (SSD) storage. In an example implementation, the storage generation logic 722 generates a virtual workspace storage 712 in the cloud environment. The virtual workspace storage 712 has a file system 772 installed thereon.

At step 204, virtual desktop environments are established by attaching (e.g., automatically attaching) the virtual workspace storage to virtual compute instances in the cloud environment. The virtual compute instances are configured to access the file system that is installed on the virtual workspace storage. A first lifecycle of the virtual workspace storage is independent from respective second lifecycles of the virtual compute instances. In an aspect, the virtual workspace storage is configured as a persistent storage on the virtual compute instances. In another aspect, the virtual workspace storage is configured as a data disk on the virtual compute instances. In yet another aspect, the virtual workspace storage is configured as a folder stored on a data disk on the virtual compute instances. In still another aspect, the virtual workspace storage is associated with a user or a group of users. For instance, the virtual workspace storage may enable multiple users to share common assets with performance of a locally attached storage (i.e., storage located on a device of a user). In another aspect, the virtual workspace storage is attached to the virtual compute instances in parallel or simultaneously. In yet another aspect, the virtual compute instances are attributed to respective users. In an example of this aspect, the users are associated with a common (e.g., same) project. For instance, as each new user is added to the project, a virtual compute instance associated with the new user may be automatically attached to the virtual workspace storage. In still another aspect, the virtual compute instances are attributed to a common (e.g., same) user. In an example implementation, the attachment logic 724 establishes virtual desktop environments 774 by attaching the virtual workspace storage 712 to virtual compute instances 714 in the cloud environment. The virtual compute instances 714 are configured to access the file system 772 that is installed on the virtual workspace storage 712. A first lifecycle of the virtual workspace storage 712 is independent from respective second lifecycles of the virtual compute instances 714. In an aspect, the lifecycle configuration logic 744 configures the first lifecycle of the virtual workspace storage 712 to be independent from the respective second lifecycles of the virtual compute instances 714.

In an example embodiment, the virtual workspace storage stores tool(s), asset(s), and/or application(s). A tool is code (e.g., software code). For instance, the code may define (e.g., be) an application. In an example, the application is configured to run on a particular operating system (e.g., a Windows® 11 operating system, a Windows® on ARM operating system, or a Linux® operating system). In another example, the application is a runtime that is configured to run on a particular operating system. In yet another example, the application is a model runtime. A model runtime is a runtime that is capable of executing a model (e.g., an AI model). An asset is data. For instance, the data may include (e.g., be) an artificial intelligence (AI) model, graphics, an image, or text.

In another example embodiment, content of the virtual workspace storage persists across multiple user sessions (e.g., in context of training an AI model, preprocessing data, or building a video game). A user session is a period of time during which a user remains in continuous communication with a virtual desktop environment. In an example, the user session is defined to start at a time instance at which an initial interaction is received by the virtual desktop environment from the user. In another example, the user session is defined to end based on a designated (e.g., predefined) amount of time passing since a most recent interaction between the user and the virtual desktop environment during the session without another interaction occurring between the user and the virtual desktop environment. In an aspect of this embodiment, a change that is made to the content in a first user session is accessible in a second user session.

In yet another example embodiment, attaching the virtual workspace storage to the virtual compute instances at step 204 triggers integration of an application, which is included in the file system, into a shell of an operating system that executes on the virtual compute instances. Examples of an application that may be included in the file system include but are not limited to a developer tool (e.g., an AI service suite, an IDE, or a web development platform), a compiler, a word processor, a spreadsheet program, and a presentation program. In an aspect, the shell of the operating system is a start menu of the operating system. In an example implementation, the integration logic 750 integrates the application, which is included in the file system 772, into the shell of the operating system that executes on the virtual compute instances 714. In an aspect of this implementation, the attachment logic 724 attaching the virtual workspace storage 712 to the virtual compute instances 714 triggers the integration logic 750 to integrate the application into the shell of the operating system.

In some example embodiments, one or more steps 202 and/or 204 of flowchart 200 may not be performed. Moreover, steps in addition to or in lieu of steps 202 and/or 204 may be performed. For instance, in an example storage embodiment, the method of flowchart 200 further includes storing the virtual workspace storage and the virtual compute instances in a common (e.g., same) geographical region. For instance, the common geographical region may be a city, county, state, geographic portion of a country (e.g., north, east, south, or west), a country, or a collection of countries (e.g., Europe, Asia, or the Middle East). In an aspect, the geographical region corresponds to a territory associated with a particular data center. In an example of this aspect, the geographical region is defined by a boundary of the territory associated with the particular data center. In another aspect, storing the virtual workspace storage and the virtual compute instances in the common geographical region causes the virtual workspace storage to have a response time similar to or same as a local drive. In an example implementation, the lifecycle configuration logic 744 stores the virtual workspace storage 712 and the virtual compute instances 714 in the common geographical region.

In an example instance termination embodiment, the method of flowchart 200 further includes, in response to attaching the virtual workspace storage to the virtual compute instances, terminating an identified virtual compute instance without terminating the virtual workspace storage as a result of the first lifecycle of the virtual workspace storage being independent from the respective second lifecycle of the identified virtual compute instance. In accordance with this embodiment, the identified virtual compute instance is included in the virtual compute instances. In an example implementation, the termination logic 728 terminates the identified virtual compute instance without terminating the virtual workspace storage 712 as a result of the first lifecycle of the virtual workspace storage 728 being independent from the respective second lifecycle of the identified virtual compute instance. In accordance with this implementation, the virtual compute instances 714 include the identified virtual compute instance. In an aspect, the termination logic 728 generates a termination indicator 768 to indicate that the identified virtual compute instance has been terminated.

In an aspect of the instance termination embodiment, the method of flowchart 200 further includes, in response to terminating the identified virtual compute instance, attaching the virtual workspace storage to a specified virtual compute instance that is external to the virtual compute instances. The first lifecycle of the virtual workspace storage is independent from a third lifecycle of the specified virtual compute instance. In an example implementation, the attachment logic 724 attaches the virtual workspace storage 712 to the specified virtual compute instance, which is external to the virtual compute instances 714, in response to the termination logic 728 terminating the identified virtual compute instance. In further accordance with this implementation, the first lifecycle of the virtual workspace storage 712 is independent from the third lifecycle of the specified virtual compute instance. In an aspect, the attachment logic 724 attaches the virtual workspace storage 712 to the specified virtual compute instance in response to receipt of the termination indicator 768 (e.g., as a result of the termination indicator 768 indicating that the identified virtual compute instance has been terminated).

In another aspect of the instance termination embodiment, the method of flowchart 200 further includes, in response to terminating the identified virtual compute instance, maintaining attachment of the virtual workspace storage to a specified virtual compute instance that is included in the virtual compute instances. In an example implementation, the attachment logic 724 maintains attachment of the virtual workspace storage 712 to the specified virtual compute instance, which is included in the virtual compute instances 714, in response to the termination logic 728 terminating the identified virtual compute instance.

In an example installation representation embodiment, the method of flowchart 200 further includes installing an application on the virtual workspace storage. In an example implementation, the installation logic 738 installs the application on the virtual workspace storage 712. In accordance with the installation representation embodiment, attaching the virtual workspace storage to the virtual compute instances at step 204 includes, as a result of the application being installed on the virtual workspace storage, causing the application to be represented as being installed on an operating system that executes on the virtual compute instances. In an example implementation, as a result of the installation logic 738 installing the application on the virtual workspace storage 712, the attachment logic 724 causes the application to be represented as being installed on the operating system that executes on the virtual compute instances 714. In an aspect, the attachment logic 724 generates an interface element, which indicates that the application is installed on the operating system. In an example of this aspect, the attachment logic 724 incorporates the interface element into a user interface that is accessible (e.g., provided) to the virtual compute instances 714. In another aspect, attaching the virtual workspace storage to the virtual compute instances at step 204 includes loading the application into memory (i.e., RAM) instances of the virtual compute instances.

In an example folder configuration embodiment, the method of flowchart 200 further includes configuring a folder in the file system to be read-only with regard to a first virtual compute instance in the virtual compute instances and to be read-write with regard to a second virtual compute instance in the virtual compute instances. In an example implementation, the folder configuration logic 740 configures a folder in the file system 772 to be read-only with regard to the first virtual compute instance and to be read-write with regard to the second virtual compute instance. In accordance with this implementation, the virtual compute instances 714 include the first virtual compute instance and the second virtual compute instance.

In an example access level embodiment, the method of flowchart 200 further includes assigning access levels to respective entities. The access levels indicate respective extents to which content of the virtual workspace storage is accessible by the respective entities. Any two or more of the access levels may be same or different. For instance, each access level may differ from the other access levels. In an aspect, the extent to which the content of the virtual workspace storage is accessible by an entity may indicate a type of access (e.g., read access, write access, or read-write access) that is granted to the entity or denied to the entity, a condition under which access is granted (e.g., with regard to a particular type of access) to the entity, and so on. Read access to content is access that enables an entity to read the content. Write access to content is access that enables an entity to modify the content (e.g., add information to the content or delete information from the content). Read-write access to content is access that enables an entity to read the content and to modify the content. In an example implementation, the access logic 742 assigns the access levels to the respective entities. In accordance with this implementation, the access levels indicate respective extents to which content of the virtual workspace storage 712 is accessible by the respective entities.

In an example snapshot embodiment, the method of flowchart 200 further includes capturing snapshots of content of the virtual workspace storage periodically at respective periodic time instances. In an aspect, capturing the snapshots of the content of the virtual workspace storage obviates a need for the virtual compute instances to have a capability to capture such snapshots. In an example implementation, the snapshot logic 730 captures the snapshots of content of the virtual workspace storage 712 periodically at the respective periodic time instances. In an aspect of this embodiment, the method of flowchart 200 further includes recovering a designated snapshot of the content of the virtual workspace storage that is captured at a designated time instance. The designated time instance is included in the respective periodic time instances. The snapshots include the designated snapshot. In an aspect, the snapshots of the content of the virtual workspace storage are captured without capturing a snapshot of a drive that stores an operating system of a virtual compute instance, which may reduce a cost associated with storage and/or enable a faster recovery from a misconfiguration of the virtual compute instance. In an example implementation, the recovery logic 732 recovers the designated snapshot of the content of the virtual workspace storage 712 that is captured at the designated time instance. In an example, the snapshot logic 730 provides snapshot(s) 770 to the recovery logic 732 for processing. In accordance with this example, the snapshot(s) 770 include the designated snapshot.

In an example physical machine embodiment, the method of flowchart 200 further includes attaching the virtual workspace storage to a physical machine, which is configured to access the file system that is installed on the virtual workspace storage. In an example implementation, the attachment logic 724 attaches the virtual workspace storage 712 to the physical machine. In accordance with this implementation, the physical machine is configured to access the file system 772, which is installed on the virtual workspace storage 712. In accordance with the physical machine embodiment, the virtual workspace storage is configured as a data disk on the physical machine or as a folder stored on the data disk. In an example implementation, the virtual workspace storage 712 is configured as the data disk on the physical machine or as the folder stored on the data disk.

In an example type selection embodiment, the method of flowchart 200 includes one or more of the steps shown in flowchart 300 of FIG. 3. In an aspect, one or more of the steps shown in flowchart 300 are included in step 202 of flowchart 200. As shown in FIG. 3, the method of flowchart 300 begins at step 302. In step 302, at least an identified subset of operating systems that is to be utilized by the virtual compute instances is determined. In an aspect, determining at least the identified subset of the operating systems at step 302 includes identifying all of the operating system that are to be utilized by the virtual compute instances. In another aspect, determining at least the identified subset of the operating systems at step 302 includes identifying fewer than all of the operating system that are to be utilized by the virtual compute instances. In an example implementation, the operating system determination logic 734 determines at least the identified subset of the operating systems that is to be utilized by the virtual compute instances 714. The operating system determination logic 714 generates operating system information 756, which indicates at least the identified subset of the operating systems. In an aspect, the operating system information 756 describes the identified subset of the operating systems. In another aspect, the operating system information 756 indicates (e.g., describes) attributes of the identified subset of the operating systems.

At step 304, an identified file system type is selected from file system types that are compatible with respective subsets of the operating systems as a result of the identified file system type being compatible with the identified subset of the operating systems. In an aspect, a first file system type is compatible with a first subset of the operating systems; a second file system type is compatible with a second subset of the operating systems, and so on. Compatibility between the file system types and the subsets of the operating systems may be determined in any of a variety of ways. For instance, attributes of the file system types may be cross-referenced with attributes of the operating systems to determine the subsets of the operating systems that are compatible with the file system types. In an example implementation, the type selection logic 736 selects the identified file system type from file system types that are compatible with the respective subsets of the operating systems. In accordance with this implementation, the type selection logic 736 selects the identified file system type as a result of the identified file system type being compatible with the identified subset of the operating systems. In an aspect, the type selection logic 736 compares attributes of the identified file system type and attributes of the identified subset of the operating systems (e.g., as indicated by the operating system information 756) to determine that the identified file system type is compatible with the identified subset of the operating systems. In an example of this aspect, the type selection logic 736 makes the determination as a result of a difference between the attributes of the identified file system type and the attributes of the identified subset of the operating systems being less than or equal to a threshold difference. The type selection logic 736 generates a type indicator 758 to indicate the identified file system type.

At step 306, the file system is installed on the virtual workspace storage as a result of the file system being the identified file system type. In an example implementation, the installation logic 738 installs the file system on the virtual workspace storage 712 as a result of the file system being the identified file system type.

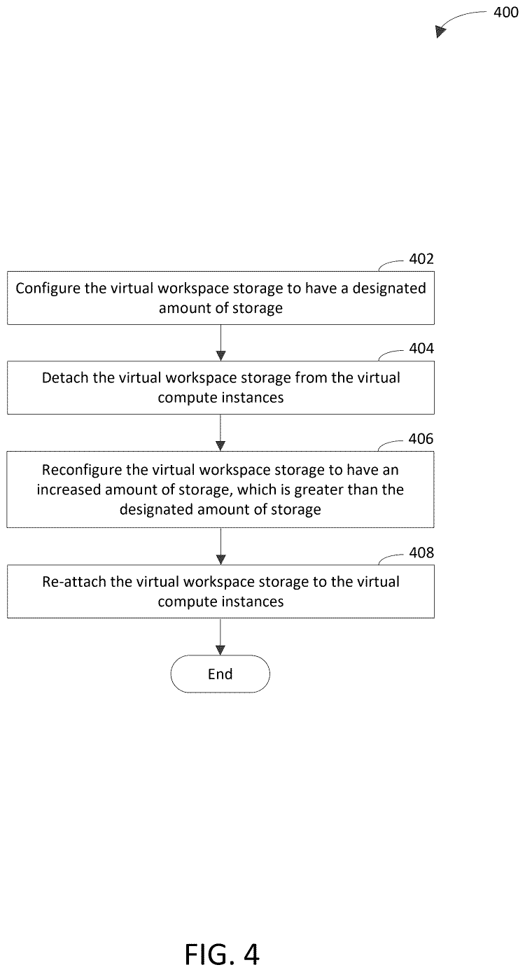

In an example storage increasing embodiment, the method of flowchart 200 includes one or more of the steps shown in flowchart 400 of FIG. 4. As shown in FIG. 4, the method of flowchart 400 begins at step 402. In step 402, the virtual workspace storage is configured to have a designated amount of storage. In an aspect, step 402 is included in step 202 of flowchart 200. In an example implementation, the attachment logic 724 configures the virtual workspace storage 712 to have the designated amount of storage.

At step 404, the virtual workspace storage is detached from the virtual compute instances. In an example implementation, the detachment logic 752 detaches the virtual workspace storage 712 from the virtual compute instances 714. In an aspect of this implementation, the detachment logic 752 detaches the virtual workspace storage 712 from the virtual compute instances 714 in response to receipt of a reconfiguration request 762 that requests reconfiguring the virtual workspace storage 712 to have an increased amount of storage. The detachment logic 752 generates a reconfiguration instruction 764, which instructs the reconfiguration logic 726 to reconfigure the virtual workspace storage 712 to have the increased amount of storage.

At step 406, the virtual workspace storage is reconfigured to have an increased amount of storage, which is greater than the designated amount of storage. In an example implementation, the reconfiguration logic 726 reconfigures the virtual workspace storage 712 to have the increased amount of storage. In an aspect of this implementation, the reconfiguration logic 726 reconfigures the virtual workspace storage 712 to have the increased amount of storage in response to receipt of the reconfiguration instruction 764 (e.g., as a result of the reconfiguration instruction 764 instructing the reconfiguration logic 726 to reconfigure the virtual workspace storage 712 to have the increased amount of storage). In another aspect, the reconfiguration logic 726 generates a reconfigured virtual workspace storage 766 by reconfiguring the virtual workspace storage 712 to have the increased amount of storage.

At step 408, in response to reconfiguring the virtual workspace storage, the virtual workspace storage is re-attached to the virtual compute instances. In an example implementation, in response to the virtual workspace storage 712 being reconfigured, the re-attachment logic 754 re-attaches the virtual workspace storage 712 to the virtual compute instances 714. In an aspect of this implementation, in response to the virtual workspace storage 712 being reconfigured to provide the reconfigured virtual workspace storage 766, the re-attachment logic 754 attaches the reconfigured virtual workspace storage 766, which is a reconfigured version of the virtual workspace storage 712, to the virtual compute instances 714.

In an aspect of the storage increasing embodiment, the virtual workspace storage is represented as a disk drive in the virtual compute instances. In accordance with this aspect, reconfiguring the virtual workspace storage to have the increased amount of storage includes adding an additional storage block to the virtual workspace storage. In further accordance with this aspect, re-attaching the virtual workspace storage to the virtual compute instances causes (e.g., triggers) the additional storage block to be represented as empty space in the disk drive.

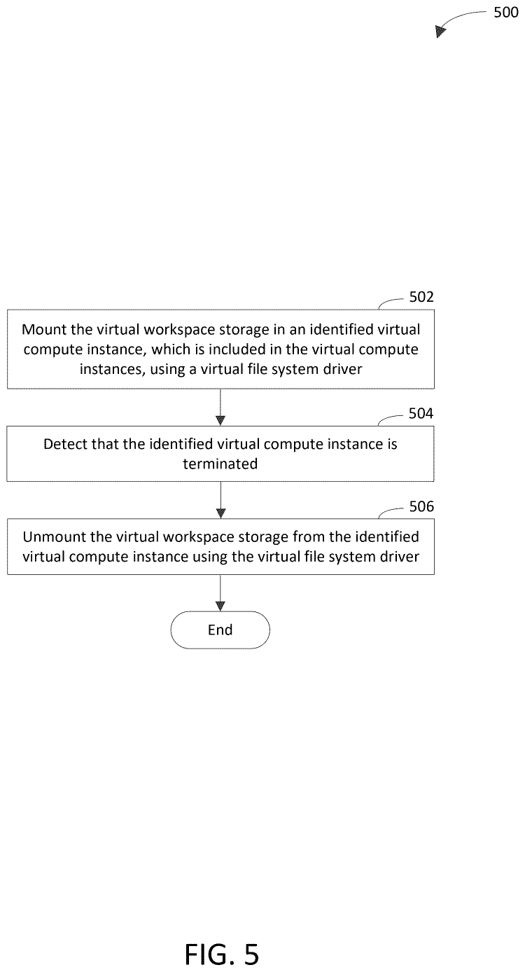

In an example driver embodiment, the method of flowchart 200 includes one or more of the steps shown in flowchart 500 of FIG. 5. As shown in FIG. 5, the method of flowchart 500 begins at step 502. In step 502, the virtual workspace storage is mounted (e.g., automatically mounted) in an identified virtual compute instance using a virtual file system driver. The identified virtual compute instance is included in the virtual compute instances. In an aspect, the virtual file system driver is a filesystem in userspace (FUSE) driver. A FUSE driver is a driver that enables filesystem(s) to be created and managed in a user space (e.g., rather than in a kernel space). Examples of a FUSE driver include but are not limited to a BlobFuse™ driver, developed and distributed by Microsoft Corporation, and a VMware® host-guest file system (HGFS) driver, developed and distributed by VMware LLC. In another aspect, step 502 is included in step 204 of flowchart 200. In an example implementation, the mounting logic 746 mounts the virtual workspace storage 712 in the identified virtual compute instance, which is included in the virtual compute instances 714, using a virtual file system driver 760.

At step 504, it is detected that the identified virtual compute instance is terminated. In an example implementation, the termination logic 728 detects that the identified virtual compute instance is terminated. The termination logic 728 generates a termination indicator 768 to indicate that the identified virtual compute instance is terminated.

At step 506, in response to detecting that the identified virtual compute instance is terminated, the virtual workspace storage is unmounted from the identified virtual compute instance using the virtual file system driver. In an example implementation, in response to detecting that the identified virtual compute instance is terminated, the unmounting logic 748 unmounts the virtual workspace storage 712 from the identified virtual compute instance using the virtual file system driver 760. In an aspect, the unmounting logic 748 unmounts the virtual workspace storage 712 as a result of the termination indicator 768 indicating that the identified virtual compute instance is terminated.

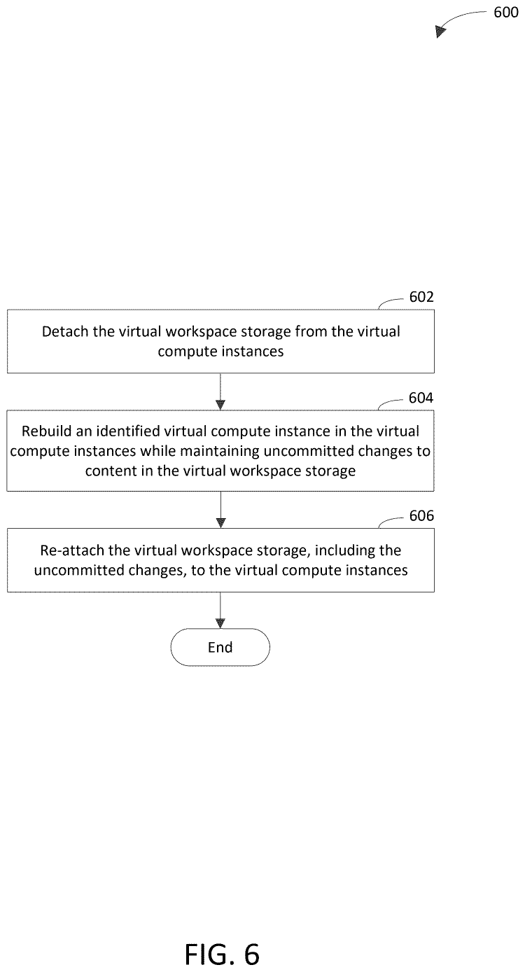

In an example rebuilding embodiment, the method of flowchart 200 includes one or more of the steps shown in flowchart 600 of FIG. 6. As shown in FIG. 6, the method of flowchart 600 begins at step 602. In step 602, the virtual workspace storage is detached from the virtual compute instances. In an example implementation, the detachment logic 752 detaches the virtual workspace storage 712 from the virtual compute instances 714. The detachment logic 752 generates a reconfiguration instruction 764, which instructs the reconfiguration logic 726 to rebuild an identified virtual compute instance, which is included in the virtual compute instances 714.

At step 604, an identified virtual compute instance is rebuilt while maintaining uncommitted changes to content in the virtual workspace storage. The identified virtual compute instance is included in the virtual compute instances. In an aspect, the identified virtual compute instance is rebuilt by updating an operating system that executes on the identified virtual compute instance from a first version to a second version. In another aspect, the identified virtual compute instance is rebuilt by changing a configuration (e.g., a CPU, a memory, or network setting(s)) of the identified virtual compute instance. In yet an aspect, the identified virtual compute instance is rebuilt by updating tool(s) that are to be utilized by the identified virtual compute instance from a first version to a second version. For instance, the tool(s) may be installed on the virtual workspace storage. In still another aspect, the identified virtual compute instance is rebuilt by installing new tool(s), which are configured to be executed by at least a subset of the virtual compute instances (e.g., at least the identified virtual compute instance), on the virtual workspace storage. In an example implementation, the reconfiguration logic 726 rebuilds the identified virtual compute instance, which is included in the virtual compute instances 714, while maintaining uncommitted changes to content in the virtual workspace storage 712. In an aspect of this implementation, the reconfiguration logic 726 rebuilds the identified virtual compute instance in response to receipt of the reconfiguration instruction 764 (e.g., as a result of the reconfiguration instruction 764 instructing the reconfiguration logic 726 to rebuild the identified virtual compute instance). In another aspect, the reconfiguration logic 726 generates a rebuilt virtual compute instance 776 by rebuilding the identified virtual compute instance.

At step 606, in response to rebuilding the identified virtual compute instance, the virtual workspace storage, including the uncommitted changes, is re-attached to the virtual compute instances. In an example implementation, in response to the identified virtual compute instance being rebuilt, the re-attachment logic 754 re-attaches the virtual workspace storage 712, including the uncommitted changes, to the virtual compute instances 714. In an aspect of this implementation, in response to the identified virtual compute instance being rebuilt to provide the rebuilt virtual compute instance 776, the re-attachment logic 754 attaches the virtual workspace storage 766, including the uncommitted changes, to the rebuilt virtual compute instance 776, which is a rebuilt version of the identified virtual compute instance.

It will be recognized that the computing system 700 may not include one or more of the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, and/or the re-attachment logic 754. Furthermore, the computing system 700 may include components in addition to or in lieu of the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, and/or the re-attachment logic 754.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the independent lifecycle-based virtual desktop environment logic 108, the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, the re-attachment logic 754, flowchart 200, flowchart 300, flowchart 400, flowchart 500, and/or flowchart 600 may be implemented in hardware, software, firmware, or any combination thereof.

For example, any one or more of the independent lifecycle-based virtual desktop environment logic 108, the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, the re-attachment logic 754, flowchart 200, flowchart 300, flowchart 400, flowchart 500, and/or flowchart 600 may be implemented, at least in part, as computer program code configured to be executed in one or more processors.

In another example, any one or more of the independent lifecycle-based virtual desktop environment logic 108, the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, the re-attachment logic 754, flowchart 200, flowchart 300, flowchart 400, flowchart 500, and/or flowchart 600 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an example, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

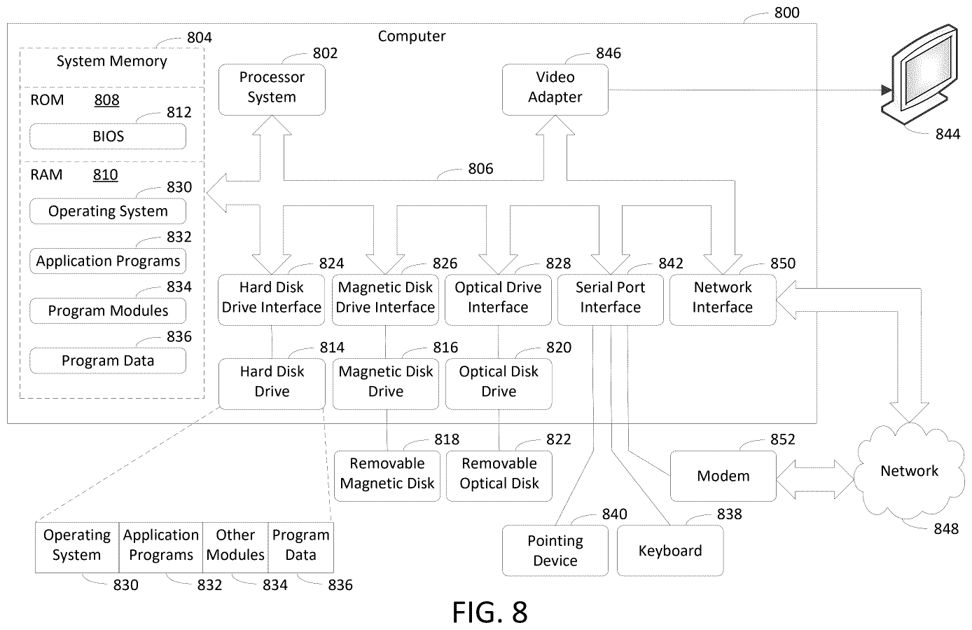

(A1) An example system (FIG. 1, 102A-102M, 106A-106N; FIG. 7, 700; FIG. 8, 800) comprises a processor system (FIG. 8, 802) and a memory (FIG. 8, 804, 808, 810) that stores computer-executable instructions. The computer-executable instructions are executable by the processor system to at least generate (FIG. 2, 202) a virtual workspace storage (FIG. 7, 712) in a cloud environment. The virtual workspace storage has a file system (FIG. 7, 772) installed thereon. The computer-executable instructions are executable by the processor system further to at least establish (FIG. 2, 204) a plurality of virtual desktop environments (FIG. 7, 774) by attaching the virtual workspace storage to a plurality of virtual compute instances (FIG. 7, 714), which are configured to access the file system that is installed on the virtual workspace storage, in the cloud environment. A first lifecycle of the virtual workspace storage is independent from a plurality of respective second lifecycles of the plurality of virtual compute instances.
(A2) In the example system of A1, wherein the virtual workspace storage is configured as a data disk on the plurality of virtual compute instances.
(A3) In the example system of any of A1-A2, wherein the virtual workspace storage is configured as a folder stored on a data disk on the plurality of virtual compute instances.
(A4) In the example system of any of A1-A3, wherein the file system is a new technology file system.
(A5) In the example system of any of A1-A4, wherein the computer-executable instructions are executable by the processor system to at least: determine at least an identified subset of a plurality of operating systems that is to be utilized by the plurality of virtual compute instances; select an identified file system type from a plurality of file system types that are compatible with respective subsets of the plurality of operating systems as a result of the identified file system type being compatible with the identified subset of the plurality of operating systems; and install the file system on the virtual workspace storage as a result of the file system being the identified file system type.
(A6) In the example system of any of A1-A5, wherein the computer-executable instructions are executable by the processor system to at least: configure the virtual workspace storage to have a designated amount of storage; detach the virtual workspace storage from the plurality of virtual compute instances; reconfigure the virtual workspace storage to have an increased amount of storage, which is greater than the designated amount of storage; and in response to the virtual workspace storage being reconfigured, re-attach the virtual workspace storage to the plurality of virtual compute instances.
(A7) In the example system of any of A1-A6, wherein the virtual workspace storage is represented as a disk drive in the plurality of virtual compute instances; wherein the computer-executable instructions are executable by the processor system to reconfigure the virtual workspace storage to have the increased amount of storage by adding an additional storage block to the virtual workspace storage; and wherein the virtual workspace storage being re-attached to the plurality of virtual compute instances causes the additional storage block to be represented as empty space in the disk drive.
(A8) In the example system of any of A1-A7, wherein the computer-executable instructions are executable by the processor system to at least: mount the virtual workspace storage in an identified virtual compute instance, which is included in the plurality of virtual compute instances, using a virtual file system driver; detect that the identified virtual compute instance is terminated; and in response to detection that the identified virtual compute instance is terminated, unmount the virtual workspace storage from the identified virtual compute instance using the virtual file system driver.
(A9) In the example system of any of A1-A8, wherein the computer-executable instructions are executable by the processor system further to at least: in response to the virtual workspace storage being attached to the plurality of virtual compute instances, terminate an identified virtual compute instance without terminating the virtual workspace storage as a result of the first lifecycle of the virtual workspace storage being independent from the respective second lifecycle of the identified virtual compute instance, wherein the identified virtual compute instance is included in the plurality of virtual compute instances.
(A10) In the example system of any of A1-A9, wherein the computer-executable instructions are executable by the processor system further to at least: in response to the identified virtual compute instance being terminated, attach the virtual workspace storage to a specified virtual compute instance that is external to the plurality of virtual compute instances, wherein the first lifecycle of the virtual workspace storage is independent from a third lifecycle of the specified virtual compute instance.
(A11) In the example system of any of A1-A10, wherein the computer-executable instructions are executable by the processor system further to at least: in response to the identified virtual compute instance being terminated, maintain attachment of the virtual workspace storage to a specified virtual compute instance that is included in the plurality of virtual compute instances.
(A12) In the example system of any of A1-A11, wherein the computer-executable instructions are executable by the processor system to at least: install an application on the virtual workspace storage; and as a result of the application being installed on the virtual workspace storage, cause the application to be represented as being installed on an operating system that executes on the plurality of virtual compute instances.
(A13) In the example system of any of A1-A12, wherein the computer-executable instructions are executable by the processor system further to at least: configure a folder in the file system to be read-only with regard to a first virtual compute instance in the plurality of virtual compute instances and to be read-write with regard to a second virtual compute instance in the plurality of virtual compute instances.
(A14) In the example system of any of A1-A13, wherein the computer-executable instructions are executable by the processor system further to at least: assign a plurality of access levels to a plurality of respective entities, the plurality of access levels indicating respective extents to which content of the virtual workspace storage is accessible by the plurality of respective entities.
(A15) In the example system of any of A1-A14, wherein the computer-executable instructions are executable by the processor system to at least: trigger integration of an application, which is included in the file system, into a shell of an operating system that executes on the plurality of virtual compute instances as a result of the virtual workspace storage being attached to the plurality of virtual compute instances.
(A16) In the example system of any of A1-A15, wherein the computer-executable instructions are executable by the processor system further to at least: capture snapshots of content of the virtual workspace storage periodically at respective periodic time instances.
(A17) In the example system of any of A1-A16, wherein the computer-executable instructions are executable by the processor system further to at least: recover a designated snapshot of the content of the virtual workspace storage that is captured at a designated time instance, which is included in the respective periodic time instances, wherein the snapshots include the designated snapshot.
(A18) In the example system of any of A1-A17, wherein the computer-executable instructions are executable by the processor system further to at least: attach the virtual workspace storage to a physical machine, which is configured to access the file system that is installed on the virtual workspace storage; and wherein the virtual workspace storage is configured as a data disk on the physical machine or as a folder stored on the data disk.
(A19) In the example system of any of A1-A18, wherein the computer-executable instructions are executable by the processor system further to at least: detach the virtual workspace storage from the plurality of virtual compute instances; rebuild an identified virtual compute instance in the plurality of virtual compute instances while maintaining uncommitted changes to content in the virtual workspace storage; and in response to the identified virtual compute instance being rebuilt, re-attach the virtual workspace storage, including the uncommitted changes, to the plurality of virtual compute instances.
(B1) An example method is implemented by a computing system (FIG. 1, 102A-102M, 106A-106N; FIG. 7, 700; FIG. 8, 800). The method comprises generating (FIG. 2, 202) a virtual workspace storage (FIG. 7, 712) in a cloud environment. The virtual workspace storage has a file system (FIG. 7, 772) installed thereon. The method further comprises establishing (FIG. 2, 204) a plurality of virtual desktop environments (FIG. 7, 774) by attaching the virtual workspace storage to a plurality of virtual compute instances (FIG. 7, 714), which are configured to access the file system that is installed on the virtual workspace storage, in the cloud environment. A first lifecycle of the virtual workspace storage is independent from a plurality of respective second lifecycles of the plurality of virtual compute instances.
(B2) In the example method of B1, wherein the virtual workspace storage is configured as a data disk on the plurality of virtual compute instances.
(B3) In the example method of any of B1-B2, wherein the virtual workspace storage is configured as a folder stored on a data disk on the plurality of virtual compute instances.
(B4) In the example method of any of B1-B3, wherein the file system is a new technology file system.
(B5) In the example method of any of B1-B4, wherein generating the virtual workspace storage comprises: determining at least an identified subset of a plurality of operating systems that is to be utilized by the plurality of virtual compute instances; selecting an identified file system type from a plurality of file system types that are compatible with respective subsets of the plurality of operating systems as a result of the identified file system type being compatible with the identified subset of the plurality of operating systems; and installing the file system on the virtual workspace storage as a result of the file system being the identified file system type.
(B6) In the example method of any of B1-B5, wherein generating the virtual workspace storage comprises: configuring the virtual workspace storage to have a designated amount of storage; and wherein the method further comprises: detaching the virtual workspace storage from the plurality of virtual compute instances; reconfiguring the virtual workspace storage to have an increased amount of storage, which is greater than the designated amount of storage; and in response to reconfiguring the virtual workspace storage, re-attaching the virtual workspace storage to the plurality of virtual compute instances.
(B7) In the example method of any of B1-B6, wherein the virtual workspace storage is represented as a disk drive in the plurality of virtual compute instances; wherein reconfiguring the virtual workspace storage to have the increased amount of storage comprises: adding an additional storage block to the virtual workspace storage; and wherein re-attaching the virtual workspace storage to the plurality of virtual compute instances causes the additional storage block to be represented as empty space in the disk drive.
(B8) In the example method of any of B1-B7, wherein attaching the virtual workspace storage to the plurality of virtual compute instances comprises: mounting the virtual workspace storage in an identified virtual compute instance, which is included in the plurality of virtual compute instances, using a virtual file system driver; and wherein the method further comprises: detecting that the identified virtual compute instance is terminated; and in response to detecting that the identified virtual compute instance is terminated, unmounting the virtual workspace storage from the identified virtual compute instance using the virtual file system driver.
(B9) In the example method of any of B1-B8, further comprising: in response to attaching the virtual workspace storage to the plurality of virtual compute instances, terminating an identified virtual compute instance without terminating the virtual workspace storage as a result of the first lifecycle of the virtual workspace storage being independent from the respective second lifecycle of the identified virtual compute instance, wherein the identified virtual compute instance is included in the plurality of virtual compute instances.
(B10) In the example method of any of B1-B9, further comprising: in response to terminating the identified virtual compute instance, attaching the virtual workspace storage to a specified virtual compute instance that is external to the plurality of virtual compute instances, wherein the first lifecycle of the virtual workspace storage is independent from a third lifecycle of the specified virtual compute instance.
(B11) In the example method of any of B1-B10, further comprising: in response to terminating the identified virtual compute instance, maintaining attachment of the virtual workspace storage to a specified virtual compute instance that is included in the plurality of virtual compute instances.
(B12) In the example method of any of B1-B11, further comprising: installing an application on the virtual workspace storage; wherein attaching the virtual workspace storage to the plurality of virtual compute instances comprises: as a result of the application being installed on the virtual workspace storage, causing the application to be represented as being installed on an operating system that executes on the plurality of virtual compute instances.
(B13) In the example method of any of B1-B12, further comprising: configuring a folder in the file system to be read-only with regard to a first virtual compute instance in the plurality of virtual compute instances and to be read-write with regard to a second virtual compute instance in the plurality of virtual compute instances.
(B14) In the example method of any of B1-B13, further comprising: assigning a plurality of access levels to a plurality of respective entities, the plurality of access levels indicating respective extents to which content of the virtual workspace storage is accessible by the plurality of respective entities.
(B15) In the example method of any of B1-B14, wherein attaching the virtual workspace storage to the plurality of virtual compute instances triggers integration of an application, which is included in the file system, into a shell of an operating system that executes on the plurality of virtual compute instances.
(B16) In the example method of any of B1-B15, further comprising: capturing snapshots of content of the virtual workspace storage periodically at respective periodic time instances.
(B17) In the example method of any of B1-B16, further comprising: recovering a designated snapshot of the content of the virtual workspace storage that is captured at a designated time instance, which is included in the respective periodic time instances, wherein the snapshots include the designated snapshot.
(B18) In the example method of any of B1-B17, further comprising: attaching the virtual workspace storage to a physical machine, which is configured to access the file system that is installed on the virtual workspace storage; wherein the virtual workspace storage is configured as a data disk on the physical machine or as a folder stored on the data disk.
(B19) In the example method of any of B1-B18, further comprising: detaching the virtual workspace storage from the plurality of virtual compute instances; rebuilding an identified virtual compute instance in the plurality of virtual compute instances while maintaining uncommitted changes to content in the virtual workspace storage; and in response to rebuilding the identified virtual compute instance, re-attaching the virtual workspace storage, including the uncommitted changes, to the plurality of virtual compute instances.
(C1) An example computer program product (FIG. 8, 818, 822) comprises a computer-readable storage medium having instructions recorded thereon for enabling a processor-based system (FIG. 1, 102A-102M, 106A-106N; FIG. 7, 700; FIG. 8, 800) to perform operations. The operations comprise generating (FIG. 2, 202) a virtual workspace storage (FIG. 7, 712) in a cloud environment. The virtual workspace storage has a file system (FIG. 7, 772) installed thereon. The operations further comprise establishing (FIG. 2, 204) a plurality of virtual desktop environments (FIG. 7, 774) by attaching the virtual workspace storage to a plurality of virtual compute instances (FIG. 7, 714), which are configured to access the file system that is installed on the virtual workspace storage, in the cloud environment. A first lifecycle of the virtual workspace storage is independent from a plurality of respective second lifecycles of the plurality of virtual compute instances.

### III. Example Computer System

FIG. 8 depicts an example computer 800 in which embodiments may be implemented.

Any one or more of the user devices 102A-102M and/or any one or more of the servers 106A-106N shown in FIG. 1 and/or the computing system 700 shown in FIG. 7 may be implemented using computer 800, including one or more features of computer 800 and/or alternative features. In an example, computer 800 is a general-purpose computing device in the form of a conventional personal computer, a mobile computer, or a workstation, for example. In another example, computer 800 is a special purpose computing device. The description of computer 800 provided herein is provided for purposes of illustration, and is not intended to be limiting. Embodiments may be implemented in further types of computer systems, as would be known to persons skilled in the relevant art(s).

As shown in FIG. 8, computer 800 includes a processor system 802, a system memory 804, and a bus 806 that couples various system components including system memory 804 to processor system 802. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computer 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 830, one or more application programs 832, other program modules 834, and program data 836. In an example, application programs 832 and/or program modules 834 include computer program logic for implementing any one or more of (e.g., at least a portion of) the independent lifecycle-based virtual desktop environment logic 108, the independent lifecycle-based virtual desktop environment logic 708, the storage generation logic 722, the attachment logic 724, the reconfiguration logic 726, the termination logic 728, the snapshot logic 730, the recovery logic 732, the operating system determination logic 734, the type selection logic 736, the installation logic 738, the folder configuration logic 740, the access logic 742, the lifecycle configuration logic 744, the mounting logic 746, the unmounting logic 748, the integration logic 750, the detachment logic 752, the re-attachment logic 754, flowchart 200 (including any step of flowchart 200), flowchart 300 (including any step of flowchart 300), flowchart 400 (including any step of flowchart 400), flowchart 500 (including any step of flowchart 500), and/or flowchart 600 (including any step of flowchart 600), as described herein.

A user may enter commands and information into the computer 800 through input devices, such as keyboard 838 and pointing device 840. Other examples of an input device (not shown) include but are not limited to a microphone, a joystick, a game pad, a satellite dish, a scanner, a touch screen, a camera, an accelerometer, and a gyroscope. These and other input devices often are connected to the processor system 802 through a serial port interface 842 that is coupled to bus 806, but may be connected by other interfaces, such as a parallel port, game port, or a universal serial bus (USB).

A display device 844 (e.g., a monitor) is also connected to bus 806 via an interface, such as a video adapter 846. In an example, computer 800 includes other peripheral output devices (not shown), such as speakers and printers.

Computer 800 is connected to a network 848 (e.g., the Internet) through a network interface 850 (e.g., a network adapter), a modem 852, or other means for establishing communications over the network. Modem 852 is connected to bus 806 via serial port interface 842. In an example, modem 852 is incorporated into the computer. In another example, modem 852 is external to computer 800.

As used herein, the terms “computer program medium” and “computer-readable storage medium” are used to generally refer to media (e.g., non-transitory media) such as the hard disk associated with hard disk drive 814, removable magnetic disk 818, removable optical disk 822, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 832 and other program modules 834) may be stored on the hard disk, magnetic disk, optical disk, ROM, or RAM. Such computer programs also may be received via network interface 850 or serial port interface 842. Such computer programs, when executed or loaded by an application, enable computer 800 to implement features of embodiments discussed herein. Accordingly, such computer programs represent controllers of the computer 800.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, though each embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
generate a virtual workspace storage in a cloud environment, the virtual workspace storage having a file system installed thereon; and
establish a plurality of virtual desktop environments by attaching the virtual workspace storage to a plurality of virtual compute instances, which are configured to access the file system that is installed on the virtual workspace storage, in the cloud environment, wherein a first lifecycle of the virtual workspace storage is independent from a plurality of respective second lifecycles of the plurality of virtual compute instances.

2. The system of claim 1, wherein the virtual workspace storage is configured as a data disk on the plurality of virtual compute instances.

3. The system of claim 1, wherein the virtual workspace storage is configured as a folder stored on a data disk on the plurality of virtual compute instances.

4. The system of claim 1, wherein the computer-executable instructions are executable by the processor system to at least:
determine at least an identified subset of a plurality of operating systems that is to be utilized by the plurality of virtual compute instances;
select an identified file system type from a plurality of file system types that are compatible with respective subsets of the plurality of operating systems as a result of the identified file system type being compatible with the identified subset of the plurality of operating systems; and
install the file system on the virtual workspace storage as a result of the file system being the identified file system type.

5. The system of claim 1, wherein the computer-executable instructions are executable by the processor system to at least:
mount the virtual workspace storage in an identified virtual compute instance, which is included in the plurality of virtual compute instances, using a virtual file system driver;
detect that the identified virtual compute instance is terminated; and
in response to detection that the identified virtual compute instance is terminated, unmount the virtual workspace storage from the identified virtual compute instance using the virtual file system driver.

6. The system of claim 1, wherein the computer-executable instructions are executable by the processor system further to at least:
configure a folder in the file system to be read-only with regard to a first virtual compute instance in the plurality of virtual compute instances and to be read-write with regard to a second virtual compute instance in the plurality of virtual compute instances.

7. The system of claim 1, wherein the computer-executable instructions are executable by the processor system further to at least:
assign a plurality of access levels to a plurality of respective entities, the plurality of access levels indicating respective extents to which content of the virtual workspace storage is accessible by the plurality of respective entities.

8. The system of claim 1, wherein the computer-executable instructions are executable by the processor system to at least:
trigger integration of an application, which is included in the file system, into a shell of an operating system that executes on the plurality of virtual compute instances as a result of the virtual workspace storage being attached to the plurality of virtual compute instances.

9. The system of claim 1, wherein the computer-executable instructions are executable by the processor system further to at least:
capture snapshots of content of the virtual workspace storage periodically at respective periodic time instances.

10. The system of claim 9, wherein the computer-executable instructions are executable by the processor system further to at least:
recover a designated snapshot of the content of the virtual workspace storage that is captured at a designated time instance, which is included in the respective periodic time instances, wherein the snapshots include the designated snapshot.

11. The system of claim 1, wherein the computer-executable instructions are executable by the processor system further to at least:
detach the virtual workspace storage from the plurality of virtual compute instances;
rebuild an identified virtual compute instance in the plurality of virtual compute instances while maintaining uncommitted changes to content in the virtual workspace storage; and
in response to the identified virtual compute instance being rebuilt, re-attach the virtual workspace storage, including the uncommitted changes, to the plurality of virtual compute instances.

12. A method implemented by a computing system, the method comprising:
generating a virtual workspace storage in a cloud environment, the virtual workspace storage having a file system installed thereon; and
establishing a plurality of virtual desktop environments by attaching the virtual workspace storage to a plurality of virtual compute instances, which are configured to access the file system that is installed on the virtual workspace storage, in the cloud environment, wherein a first lifecycle of the virtual workspace storage is independent from a plurality of respective second lifecycles of the plurality of virtual compute instances.

13. The method of claim 12, wherein generating the virtual workspace storage comprises:
configuring the virtual workspace storage to have a designated amount of storage; and
wherein the method further comprises:
detaching the virtual workspace storage from the plurality of virtual compute instances;
reconfiguring the virtual workspace storage to have an increased amount of storage, which is greater than the designated amount of storage; and
in response to reconfiguring the virtual workspace storage, re-attaching the virtual workspace storage to the plurality of virtual compute instances.

14. The method of claim 13, wherein the virtual workspace storage is represented as a disk drive in the plurality of virtual compute instances;
wherein reconfiguring the virtual workspace storage to have the increased amount of storage comprises:
adding an additional storage block to the virtual workspace storage; and
wherein re-attaching the virtual workspace storage to the plurality of virtual compute instances causes the additional storage block to be represented as empty space in the disk drive.

15. The method of claim 12, further comprising:
in response to attaching the virtual workspace storage to the plurality of virtual compute instances, terminating an identified virtual compute instance without terminating the virtual workspace storage as a result of the first lifecycle of the virtual workspace storage being independent from the respective second lifecycle of the identified virtual compute instance, wherein the identified virtual compute instance is included in the plurality of virtual compute instances.

16. The method of claim 15, further comprising:
in response to terminating the identified virtual compute instance, attaching the virtual workspace storage to a specified virtual compute instance that is external to the plurality of virtual compute instances, wherein the first lifecycle of the virtual workspace storage is independent from a third lifecycle of the specified virtual compute instance.

17. The method of claim 15, further comprising:
in response to terminating the identified virtual compute instance, maintaining attachment of the virtual workspace storage to a specified virtual compute instance that is included in the plurality of virtual compute instances.

18. The method of claim 12, further comprising:
installing an application on the virtual workspace storage;
wherein attaching the virtual workspace storage to the plurality of virtual compute instances comprises:
as a result of the application being installed on the virtual workspace storage, causing the application to be represented as being installed on an operating system that executes on the plurality of virtual compute instances.

19. The method of claim 12, further comprising:
attaching the virtual workspace storage to a physical machine, which is configured to access the file system that is installed on the virtual workspace storage;
wherein the virtual workspace storage is configured as a data disk on the physical machine or as a folder stored on the data disk.

20. A computer program product comprising a computer-readable storage medium having instructions recorded thereon for enabling a processor-based system to perform operations, the operations comprising:
generating a virtual workspace storage in a cloud environment, the virtual workspace storage having a file system installed thereon; and
establishing a plurality of virtual desktop environments by attaching the virtual workspace storage to a plurality of virtual compute instances, which are configured to access the file system that is installed on the virtual workspace storage, in the cloud environment, wherein a first lifecycle of the virtual workspace storage is independent from a plurality of respective second lifecycles of the plurality of virtual compute instances.
